(19) United States
(12) Patent Application Publication
(10) Pub. No.: US 2025/0137237 A1
(43) Pub. Date: May 1, 2025

(54) SYSTEM AND METHOD FOR CONTROLLING WORK MACHINE

(71) Applicant: Komatsu Ltd., Tokyo (JP)

(72) Inventors: Akihiko Teramura, Tokyo (JP); Jin Kitajima, Tokyo (JP)

(73) Assignee: Komatsu Ltd., Tokyo (JP)

(21) Appl. No.: 18/690,760

(22) PCT Filed: Oct. 18, 2022
(86) PCT No.: PCT/JP2022/038687

§ 371 Date: Mar. 11, 2024

(30) Foreign Application Priority Data
Oct. 29, 2021 (JP) 2021-178164

(51) Int. Cl. E02F 9/26; E02F 9/20

(52) U.S. Cl. CPC E02F 9/262; E02F 9/2033

(57) ABSTRACT

A control system of a work machine including a lower traveling body and an upper turning body that can turn with respect to the lower traveling body includes a detection device attached to the upper turning body and detecting an object present around the work machine, and a controller controlling operation of the lower traveling body and the upper turning body. The controller controls the operation of the lower traveling body on the basis of a position of the object detected by the detection device and a lower traveling body stop region, and controls the operation of the upper turning body on the basis of the position of the object detected by the detection device and an upper turning body region different from the lower traveling body stop region, and the lower traveling body stop region is set in a coordinate system based on the upper turning body.

### FIELD

The present disclosure relates to a system and a method for controlling a work machine.

### BACKGROUND

In a technical field related to a work machine, a work machine including a safety device that detects an obstacle around the work machine as disclosed in Patent Literature is known.

### CITATION LIST

### Patent Literature

Patent Literature 1: Japanese Patent Application Laid-open No. 2020-007867

### SUMMARY

### Technical Problem

In Patent Literature 1, an upper coordinate system based on an upper turning body and a lower coordinate system based on a lower traveling body are used, and coordinate transformation of one into the other coordinate system is performed. Thus, a load of calculation processing of coordinate transformation is large.

### Solution to Problem

According to an aspect f the present invention, a system to control a work machine including a traveling body and a turning body that can turn with respect to the traveling body, the system comprises: a detection device that is attached to the turning body and detects an object present around the work machine; and a controller that controls operation of the traveling body and the turning body of the work machine, wherein the controller controls the operation of the traveling body on a basis of a position of the object detected by the detection device and a first set region, and controls the operation of the turning body on a basis of the position of the object detected by the detection device and a second set region different from the first set region, and the first set region is set in a coordinate system based on the turning body.

According to another aspect f the present invention, a method of controlling a work machine including a traveling body and a turning body that can turn with respect to the traveling body, the method comprises: detecting an object present around the work machine by a detection device attached to the turning body; and controlling operation of the traveling body on a basis of a position of the object detected by the detection device and a first set region, and controlling operation of the turning body on a basis of the position of the object detected by the detection device and a second set region different from the first set region by a controller that controls the operation of the traveling body and the turning body of the work machine, wherein the first set region is set in a coordinate system based on the turning body.

### Advantageous Effects of Invention

According to the present disclosure, it is possible to reduce a load of calculation processing and to appropriately control a work machine.

### BRIEF DESCRIPTION OF DRAWINGS

FIG. 1 is a perspective view illustrating a work machine according to an embodiment.

FIG. 2 is a block diagram illustrating a device configuration of the working machine according to the embodiment.

FIG. 3 is a functional block diagram illustrating a control system according to the embodiment.

FIG. 4 is a view schematically illustrating an upper turning body according to the embodiment.

FIG. 5 is a schematic view illustrating an example of an upper turning body region and a lower traveling body region.

FIG. 6 is a schematic view illustrating the upper turning body region and the lower traveling body region illustrated in FIG. 5 in a state in which the upper turning body turns.

FIG. 7 is a flowchart illustrating a control method according to the embodiment.

FIG. 8 is a block diagram illustrating a computer system according to the embodiment.

FIG. 9 is a schematic view illustrating another example of an upper turning body region and a lower traveling body region.

FIG. 10 is a schematic view illustrating another example of an upper turning body region and a lower traveling body region.

FIG. 11 is a schematic view illustrating the upper turning body region and the lower traveling body region illustrated in FIG. 10 in a state in which the upper turning body turns.

FIG. 12 is a schematic view illustrating another example of an upper turning body region and a lower traveling body region.

FIG. 13 is a schematic view illustrating another example of an upper turning body region and a lower traveling body region.

FIG. 14 is a schematic view illustrating another example of an upper turning body region and a lower traveling body region.

### DESCRIPTION OF EMBODIMENTS

Although embodiments according to the present disclosure will be described hereinafter with reference to the drawings, the present disclosure is not limited thereto. Components of the embodiments described in the following can be arbitrarily combined. Also, there is a case where a part of the components is not used.

### Work Machine

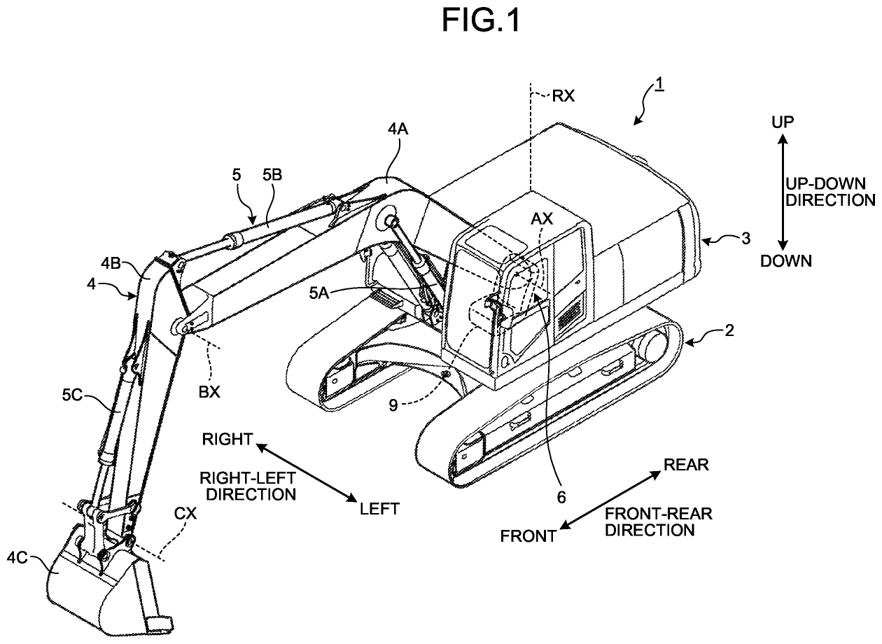

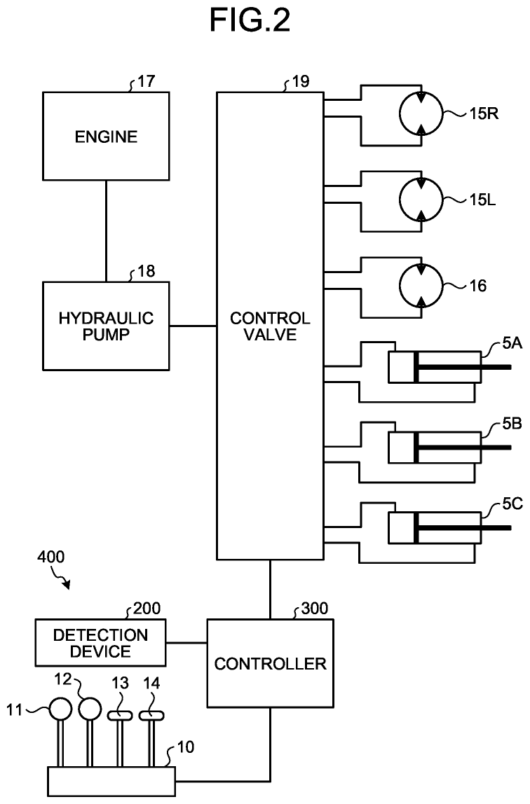

FIG. 1 is a perspective view illustrating a work machine according to an embodiment. FIG. 2 is a block diagram illustrating a device configuration of the working machine according to the embodiment. In the embodiment, it is assumed that the work machine 1 is an excavator. In the following description, the work machine 1 will be arbitrarily referred to as an excavator 1. The excavator 1 includes a lower traveling body 2 and an upper turning body 3 that can turn with respect to the lower traveling body 2. In the present embodiment, the excavator 1 includes the lower traveling body 2, the upper turning body 3 supported with respect to the lower traveling body 2 in a turnable manner, and working equipment 4 supported by the upper turning body 3.

The lower traveling body 2 includes a pair of crawler tracks. The lower traveling body 2 includes a right traveling motor 15R and a left traveling motor 15L illustrated in FIG. 2. The lower traveling body 2 rotates the crawler tracks by rotational driving of the right traveling motor 15R and the left traveling motor 15L and causes the excavator 1 to travel.

The upper turning body 3 can turn about a turning axis RX with respect to the lower traveling body 2. The excavator 1 includes a swing motor 16 to cause the upper turning body 3 to turn. The upper turning body 3 is turned by rotational force of the swing motor 16. The upper turning body 3 has a cab 6 on which an operator of the excavator 1 rides. The cab 6 is provided with a driver seat 9 on which an operator sits. The cab 6 is arranged on a front side of the upper turning body 3. The cab 6 is arranged on a left side of the working equipment 4.

The working equipment 4 includes a boom 4A coupled to the upper turning body 3, an arm 4B coupled to the boom 4A, and a bucket 4C coupled to the arm 4B. The excavator 1 includes a hydraulic cylinder 5 to drive the working equipment 4. The hydraulic cylinder 5 includes a boom cylinder 5A that drives the boom 4A, an arm cylinder 5B that drives the arm 4B, and a bucket cylinder 5C that drives the bucket 4C.

The boom 4A is supported by the upper turning body 3 in a manner of being rotatable about a boom rotation axis AX. The arm 4B is supported by the boom 4A in a manner of being rotatable about an arm rotation axis BX. The bucket 4C is supported by the arm 4B in a manner of being rotatable about a bucket rotation axis CX.

The boom rotation axis AX, the arm rotation axis BX, and the bucket rotation axis CX are parallel to each other. The boom rotation axis AX, the arm rotation axis BX, and the bucket rotation axis CX are orthogonal to an axis parallel to the turning axis RX. In the following description, a direction parallel to the turning axis RX will be appropriately referred to as an up-down direction, a direction parallel to the boom rotation axis AX, the arm rotation axis BX, and the bucket rotation axis CX will be appropriately referred to as a right-left direction, and a direction orthogonal to both the boom rotation axis AX, the arm rotation axis BX, and the bucket rotation axis CX, and the turning axis RX will be appropriately referred to as a front-rear direction. A direction in which the working equipment 4 is present with respect to the operator seated on the driver seat 9 is a front side, and an opposite direction of the front side is a rear side. One of the right and left directions with respect to the operator seated on the driver seat 9 is a right side, and an opposite direction of the right side is a left side. A direction away from a contact surface of the lower traveling body 2 is an upper side, and a direction opposite to the upper side is a lower side.

As illustrated in FIG. 2, the excavator 1 includes a power source 17, a hydraulic pump 18, a control valve 19, an operation device 10, a detection device 200, and a controller 300.

The power source 17 generates power for driving

the excavator 1. The power source 17 is, for example, an internal combustion engine. The hydraulic pump 18 is mechanically coupled to a drive shaft of the power source 17. When the power source 17 is driven, the hydraulic pump 18 is driven. The hydraulic pump 18 serves as a hydraulic oil supply source to a hydraulic drive system and drives these hydraulic devices. Note that the control valve 19 is a flow rate direction control valve, moves a spool (not illustrated) according to an operation direction of each operation lever of the operation device 10, and regulates a flow direction of hydraulic oil to each hydraulic actuator. The hydraulic oil corresponding to an operation amount of each operation lever is supplied to the hydraulic actuators such as the boom cylinder 5A, the arm cylinder 5B, the bucket cylinder 5C, the right traveling motor 15R or the left traveling motor 15L, and the swing motor 16.

The excavator 1 includes the operation device 10 arranged in the cab 6. The operation device 10 is operated for operation of at least a part of the excavator 1. The operation device 10 is operated by the operator. The operation of the excavator 1 includes at least one of operation of the lower traveling body 2, operation of the upper turning body 3, or operation of the working equipment 4. The operation device 10 outputs an operation signal indicating an operation amount of the excavator 1 to the controller 300.

The operation device 10 includes a left working lever 11 and a right working lever 12 operated for the operation of the upper turning body 3 and the working equipment 4, a left traveling lever 13 and a right traveling lever 14 operated for the operation of the lower traveling body 2, and a left foot pedal and a right foot pedal (not illustrated).

The left working lever 11 is arrange on the left side of the driver seat 9. When the left working lever 11 is operated in the front-rear direction, the arm 4B performs dumping operation or excavation operation. When the left working lever 11 is operated in the right-left direction, the upper turning body 3 performs a left turn or a right turn. The right working lever 12 is arranged on the right side of the driver seat 9. When the right working lever 12 is operated in the right-left direction, the bucket 4C performs the excavation operation or the dumping operation. When the right working lever 12 is operated in the front-rear direction, the boom 4A performs lowering operation or rising operation.

The left traveling lever 13 and the right traveling lever 14 are arranged on the front side of the driver seat 9. The left traveling lever 13 is arranged on the left side of the right traveling lever 14. When the left traveling lever 13 is operated in the front-rear direction, a left crawler track of the lower traveling body 2 makes forward movement or backward movement. When the right traveling lever 14 is operated in the front-rear direction, a right crawler track of the lower traveling body 2 makes forward movement or backward movement.

The left foot pedal and the right foot pedal are arranged on the front side of the driver seat 9. The left foot pedal is arranged on the left side of the right foot pedal. The left foot pedal is interlocked with the left traveling lever 13. The right foot pedal is interlocked with the right traveling lever 14. The lower traveling body 2 may be moved forward or moved backward when the left foot pedal and the right foot pedal are operated.

### Control System

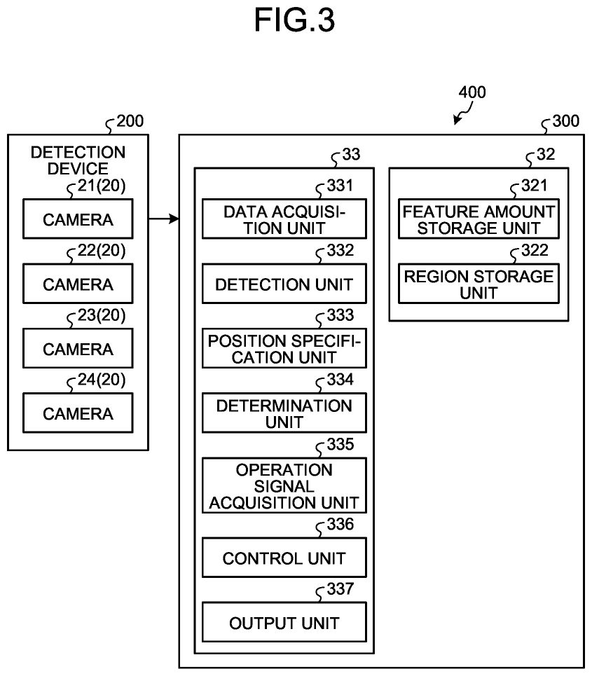

FIG. 3 is a functional block diagram illustrating a control system 400 according to the embodiment. The excavator 1 includes the control system 400. The control system 400 controls the operation of the upper turning body 3 on the basis of a position of an object detected around the excavator 1 and an upper turning body region A1 set in the coordinate system based on the upper turning body 3. The control system 400 controls the operation of the lower traveling body 2 on the basis of the position of the object detected around the excavator 1 and a lower traveling body region set in the coordinate system based on the upper turning body 3. The control system 400 includes the detection device 200 and the controller 300.

### Detection Device

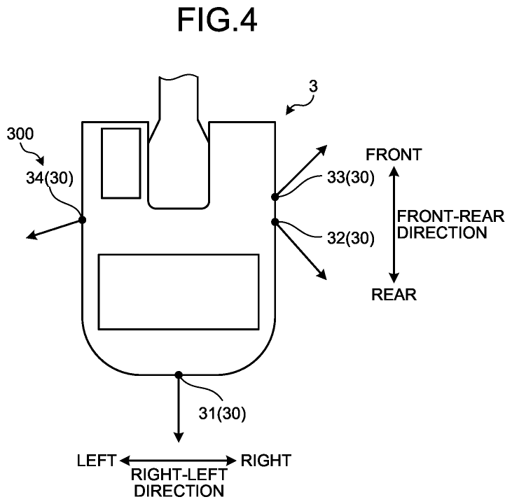

FIG. 4 is a view schematically illustrating the upper turning body according to the embodiment. The excavator 1 includes the detection device 200. The detection device 200 is a device to monitor a periphery of the excavator 1. The detection device 200 detects a person and a moving body (hereinafter, referred to as an “object”) around the excavator 1. The detection device 200 detects an object present around the excavator 1. In the present embodiment, the detection device 200 is arranged in the upper turning body 3. In the present embodiment, the detection device 200 detects a position of the object in the coordinate system based on the upper turning body 3.

In the present embodiment, the detection device 200 includes a plurality of cameras 20 (21, 22, 23, and 24). The plurality of cameras 20 is arranged in the upper turning body 3. The cameras 20 acquire images of an imaging object. As illustrated in FIG. 4, the plurality of cameras 20 is arranged around the excavator 1. In the present embodiment, the cameras 20 include a rear camera 21 arranged at a rear portion of the upper turning body 3, a right rear camera 22 and a right front camera 23 arranged at a right portion of the upper turning body 3, and a left rear camera 24 arranged at a left portion of the upper turning body 3.

The rear camera 21 images a rear region of the upper turning body 3. The right rear camera 22 images a right rear region of the upper turning body 3. The right front camera 23 images a right front region of the upper turning body 3. The left rear camera 24 images a left rear region of the upper turning body 3. Each of the plurality of cameras 20 (21, 22, 23, and 24) includes an optical system and an image sensor. The image sensor includes a couple charged device (CCD) image sensor or a complementary metal oxide semiconductor (CMOS) image sensor.

Note that the left rear camera 24 images ranges of a left side region and the left rear region of the upper turning body 3, but may image either one thereof. Similarly, the right rear camera 22 images ranges of a right side region and the right rear region of the upper turning body 3, but may image either one thereof. Similarly, the right front camera 23 images ranges of the right front region and the right side region of the upper turning body 3, but may image either one thereof. In addition, although the cameras 20 image the left rear side, the rear side, the right rear side, and the right front side of the upper turning body 3, this is not a limitation. For example, the number of cameras 20 may be different from the example illustrated in FIG. 4. For example, imaging ranges of the cameras 20 may be different from the example illustrated in FIG. 4. Furthermore, although no camera that images a front side and a left front side of the cab 6 is included in the present embodiment, this is not a limitation. A camera 20 that acquires image data indicating a situation on the front side and the left front side of the cab 6 may be included. The detection device 200 outputs the detected data to the controller 300.

### Controller

The excavator 1 includes the controller 300. The controller 300 is a device to control the excavator 1. The controller 300 controls the operation of the lower traveling body 2 and the upper turning body 3 of the excavator 1. In the present embodiment, the controller 300 is arranged in the cab 6.

The controller 300 controls the operation of the lower traveling body 2 on the basis of the position of the object detected around the excavator 1 and the lower traveling body region (described later). The controller 300 controls the operation of the upper turning body 3 on the basis of the position of the object detected around the excavator 1 and the upper turning body region A1 (described later). More specifically, the controller 300 controls the operation of the lower traveling body 2 on the basis of the position of the object detected by the detection device 200 and a lower traveling body stop region A2 and a lower traveling body deceleration region A3 set in the coordinate system based on the upper turning body 3. The controller 300 controls the turn of the upper turning body 3 on the basis of the position of the object detected by the detection device 200 and the upper turning body region A1 set in the coordinate system based on the upper turning body 3.

In a case of determining that the position of the object in the coordinate system based on the upper turning body 3 which object is detected by the detection device 200 is present in the lower traveling body stop region A2 or the lower traveling body deceleration region A3, the controller 300 performs control to limit the speed of the lower traveling body 2.

In a case of determining that the position of the object in the coordinate system based on the upper turning body 3 which object is detected by the detection device 200 is present in the lower traveling body stop region A2, the controller 300 performs control to stop the lower traveling body 2. In a case of determining that the position of the object in the coordinate system based on the upper turning body 3 which object is detected by the detection device 200 is present in the lower traveling body deceleration region A3, the controller 300 performs control to decelerate the lower traveling body 2.

The controller 300 includes a storage unit 32 including a volatile memory such as a random access memory (RAM) and a nonvolatile memory such as a read only memory (ROM), and an arithmetic processing unit 33 including a processor such as a central processing unit (CPU).

The arithmetic processing unit 33 includes a data acquisition unit 331, a detection unit 332, a position specification unit 333, a determination unit 334, an operation signal acquisition unit 335, a control unit 336, and an output unit 337 by executing a control program.

The data acquisition unit 331 acquires detection data from the detection device 200. In the present embodiment, the data acquisition unit 331 acquires image data indicating a situation of the rear side of the excavator 1 from the rear camera 21. The data acquisition unit 331 acquires image data indicating a situation of the right rear side of the excavator 1 from the right rear camera 22. The data acquisition unit 331 acquires image data indicating a situation of the right front side of the excavator 1 from the right front camera 23. The data acquisition unit 331 acquires image data indicating the left rear situation of the excavator 1 from the left rear camera 24.

The detection unit 332 detects an object including a person and a moving body present around the excavator 1 on the basis of the detection data acquired by the data acquisition unit 331. In the present embodiment, the detection unit 332 detects an object in the image data by performing image processing on the image data acquired by the data acquisition unit 331. The image processing includes processing of extracting a feature amount of the object from the image data. The detection unit 332 collates the feature amount extracted from the image data with a feature amount stored in a feature amount storage unit 321, and detects the object present around the excavator 1.

The position specification unit 333 specifies a position of the object detected by the detection device 200. The position specification unit 333 specifies the position of the detected object with respect to the upper turning body 3. More specifically, the position specification unit 333 specifies the position of the object which position is indicated by the coordinate system based on the upper turning body 3.

The determination unit 334 determines whether the object detected by the detection device 200 is present in a predetermined region. More specifically, the determination unit 334 determines whether the object is present in the upper turning body region A1, the lower traveling body stop region A2, and the lower traveling body deceleration region A3 described later. The determination unit 334 determines in which region the object is present among the inside of the upper turning body region A1, the inside of the lower traveling body stop region A2, or the outside of the lower traveling body stop region A2 and the inside of the lower traveling body deceleration region A3. The determination unit 334 collates the position of the object which position is specified by the position specification unit 333 with a position of each region stored in a region storage unit 322, and determines whether the object is present inside the upper turning body region A1. The determination unit 334 collates the position of the object which position is specified by the position specification unit 333 with the position of each region which position is stored in the region storage unit 322, and determines whether the object is present inside the lower traveling body stop region A2. The determination unit 334 collates the position of the object which position is specified by the position specification unit 333 with the position of each region stored in the region storage unit 322, and determines whether the object is present outside the lower traveling body stop region A2 and inside the lower traveling body deceleration region A3.

The operation signal acquisition unit 335 acquires an operation signal indicating an operation amount of each operation lever of the operation device 10 operated by the operator.

The control unit 336 generates a control command to control the lower traveling body 2 and the upper turning body 3 of the excavator 1. More specifically, the control unit 336 generates a control command to control the lower traveling body 2 and the upper turning body 3 on the basis of the operation amount indicated by the operation signal acquired by the operation signal acquisition unit 335. For example, the control unit 336 generates a control command to control the flow of the hydraulic oil to each of the hydraulic actuators in order to control the control valve 19 according to the operation direction of each of the operation levers of the operation device 10. The control unit 336 generates a control command to control the control valve 19 in such a manner that hydraulic oil corresponding to an operation amount of each of the operation levers is supplied to the hydraulic actuators such as the boom cylinder 5A, the arm cylinder 5B, the bucket cylinder 5C, the right traveling motor 15R or the left traveling motor 15L, and the swing motor 16.

The control unit 336 generates a control command to regulate the traveling of the lower traveling body 2 and the turn of the upper turning body 3 on the basis of a determination result of the determination unit 334. For example, in a case where the object is present in the upper turning body region A1, the control unit 336 generates the control command to regulate the turn of the upper turning body 3. For example, in a case where the object is present in the upper turning body region A1, the control unit 336 generates the control command to regulate the turn in such a manner that turning angular velocity becomes equal to or lower than upper limit angular velocity regardless of the operation amounts of the left working lever 11 and the right working lever 12 when the excavator 1 is turning. The hydraulic oil supplied to the swing motor 16 is regulated by the control command to regulate the turn, and the turning angular velocity of the upper turning body 3 is regulated to the upper limit angular velocity or lower.

After stopping the upper turning body 3, the control unit 336 maintains the turning stop state, for example, until cancellation operation of turning stop control by the operator is detected. After stopping the upper turning body 3, the control unit 336 maintains a state in which the turning angular velocity of the upper turning body 3 is regulated to be equal to or lower than the upper limit angular velocity, for example, until the cancellation operation of the turning stop control by the operator is detected. For example, even in a case where the object comes out of the upper turning body region A1 after it is detected that the object is present in the upper turning body region A1, the control unit 336 does not cancel the turning stop state until the cancellation operation is performed by the operator.

For example, in a case where the object is present in the lower traveling body stop region A2, the control unit 336 generates a control command to stop the lower traveling body 2. For example, when the excavator 1 is traveling, the control unit 336 generates a control command to regulate the traveling in such a manner that a traveling speed becomes equal to or lower than a stop speed regardless of the operation amounts of the left traveling lever 13 and the right traveling lever 14. By the control command to stop traveling, the hydraulic oil supplied to the right traveling motor 15R or the left traveling motor 15L is regulated, and the traveling speed of the lower traveling body 2 is regulated to be equal to or lower than the stop speed lower than a deceleration speed.

After stopping the lower traveling body 2, the control unit 336 maintains a traveling stop state, for example, until cancellation operation of traveling stop control by the operator is detected. After stopping the lower traveling body 2, the control unit 336 maintains the state in which the traveling speed of the lower traveling body 2 is regulated to be equal to or lower than the stop speed, for example, until the cancellation operation of the traveling stop control by the operator is detected. For example, even in a case where the object comes out of the lower traveling body stop region A2 after it is detected that the object is present in the lower traveling body stop region A2, the control unit 336 does not cancel the traveling stop state until the cancellation operation is performed by the operator.

For example, in a case where the object is present in the lower traveling body deceleration region A3, the control unit 336 generates the control command to decelerate the lower traveling body 2. For example, when the excavator 1 is traveling, the control unit 336 generates a control command to regulate the traveling in such a manner that the traveling speed becomes equal to or lower than the deceleration speed regardless of the operation amounts of the left traveling lever 13 and the right traveling lever 14. By the control command for deceleration, the hydraulic oil supplied to the right traveling motor 15R or the left traveling motor 15L is regulated, and the traveling speed of the lower traveling body 2 is regulated to be equal to or lower than the deceleration speed higher than the stop speed.

After decelerating the lower traveling body 2, the control unit 336 maintains the deceleration state, for example, until the cancellation operation of the deceleration control by the operator is detected. After decelerating the lower traveling body 2, the control unit 336 maintains a state in which the traveling speed of the lower traveling body 2 is regulated to be equal to or lower than the deceleration speed, for example, until the cancellation operation of the deceleration control by the operator is detected. For example, even in a case where the object comes out of the lower traveling body deceleration region A3 after it is detected that the object is present in the lower traveling body deceleration region A3, the control unit 336 does not cancel the deceleration state until the cancellation operation is performed by the operator.

The output unit 337 outputs the control command generated by the control unit 336 to the control valve 19.

The storage unit 32 stores various kinds of data and the like used in the processing in the arithmetic processing unit 33. In the present embodiment, the storage unit 32 includes the feature amount storage unit 321 that stores the feature amount of the object. The feature amount is information that includes an object outline, a color of the object, and the like, and that is to specify an appearance of the object. In addition, the storage unit 32 includes the region storage unit 322 that stores a set region in the present embodiment.

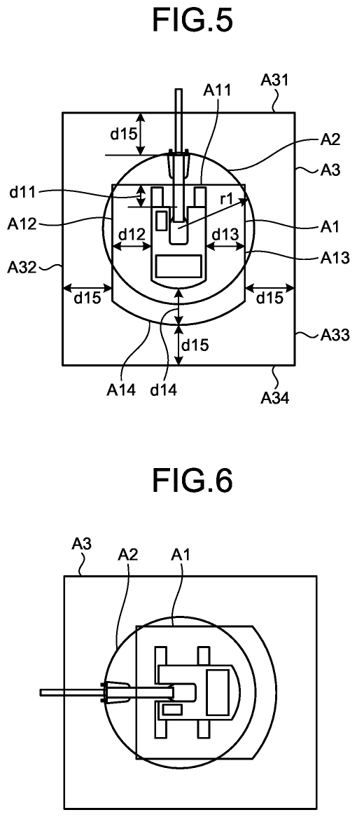

FIG. 5 is a schematic view illustrating an example of the upper turning body region and the lower traveling body region. The region storage unit 322 stores information of the upper turning body region A1 and the lower traveling body region.

The upper turning body region A1 is a second set region. The upper turning body region A1 is a region in which the turn of the upper turning body 3 is regulated when the object is detected inside. The upper turning body region A1 is set in the coordinate system based on the upper turning body 3. When the upper turning body 3 turns, the upper turning body region A1 turns together with the upper turning body 3. The upper turning body region A1 is a region necessary for the upper turning body 3 to stop without coming into contact with the object when the object is detected inside.

The lower traveling body region is a region in which the traveling of the lower traveling body 2 is regulated when the object is detected inside. The lower traveling body region is set in the coordinate system based on the upper turning body 3. When the upper turning body 3 turns, the lower traveling body region turns together with the upper turning body 3. The lower traveling body region includes the lower traveling body stop region A2 and the lower traveling body deceleration region A3.

The lower traveling body stop region A2 is a first set region. The lower traveling body stop region A2 is a region necessary for the lower traveling body 2 to stop without coming into contact with the object when the object is detected inside. In the lower traveling body stop region A2, at least a part of an outer peripheral shape has an arc shape centered on the origin of the coordinate system based on the upper turning body 3. The lower traveling body region is a region that does not come into contact with the lower traveling body 2.

The lower traveling body deceleration region A3 is a third set region. The lower traveling body deceleration region A3 is a region necessary for the lower traveling body 2 to decelerate without coming into contact with the object when the object is detected inside. The lower traveling body deceleration region A3 is a region that is wider than the lower traveling body stop region A2 and that includes the lower traveling body stop region A2. The lower traveling body deceleration region A3 is a region that is wider than the upper turning body region A1 and that includes the upper turning body region A1.

In the example illustrated in FIG. 5, the upper turning body region A1 is, for example, a region surrounded by a straight portion A11 located on the front side at a distance d11 from a front end portion of the upper turning body 3, a straight portion A12 located on a left side at a distance d12 from a left side end portion of the upper turning body 3, a straight portion A13 located on a right side at a distance d13 from a right side end portion of the upper turning body 3, and an arc portion A14 at a distance d14 from a rear end portion of the upper turning body 3. The arc portion A14 is an arc centered on the turning axis RX of the upper turning body 3. The lower traveling body stop region A2 is a region surrounded by a circle that has a radius r1 and is centered on the turning axis RX of the upper turning body 3. The lower traveling body deceleration region A3 is, for example, a rectangular region. The lower traveling body deceleration region A3 is a region having a peripheral edge portion separated from the upper turning body region A1 and the lower traveling body stop region A2 for a distance d15 or more. The lower traveling body deceleration region A3 is, for example, a region surrounded by a straight portion A31 located on a front side at a distance d15 from the front end portion of the lower traveling body stop region A2, a straight portion A32 located on a left side at the distance d15 from the left end portion of the upper turning body region A1, a straight portion A33 located on a right side at the distance d15 from the right end portion of the upper turning body region A1, and a straight portion A34 located on a rear side at the distance d15 from the rear end of the upper turning body region A1.

FIG. 6 is a schematic view illustrating the upper turning body region and the lower traveling body region illustrated in FIG. 5 in a state in which the upper turning body turns. As illustrated in FIG. 6, in a case where the upper turning body 3 turns, the upper turning body region A1, the lower traveling body stop region A2, and the lower traveling body deceleration region A3 turn together with the upper turning body 3.

### Control Method

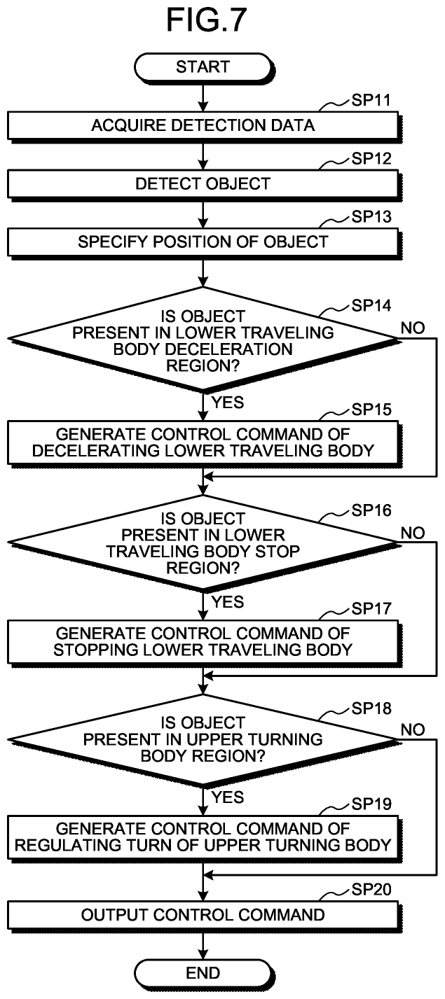

FIG. 7 is a flowchart illustrating a control method according to the embodiment. When the excavator 1 is keyed on, the detection device 200 and the controller 300 are activated.

The controller 300 acquires detection data detected by the detection device 200 (Step SP11). More specifically, the data acquisition unit 331 acquires image data around the excavator 1 which image data is captured by the cameras 20 of the detection device 200.

The controller 300 detects an object (Step SP12). More specifically, the detection unit 332 detects an object including a person and a moving body present around the excavator 1 on the basis of the detection data acquired by the data acquisition unit 331. In the present embodiment, the detection unit 332 detects an object including a person and a moving body present around the excavator 1 on the basis of the image data acquired by the data acquisition unit 331.

The controller 300 specifies a position of the object (Step SP13). More specifically, the position specification unit 333 specifies the position of the object in the coordinate system based on the upper turning body 3 which object is detected by the detection unit 332.

The controller 300 determines whether the object is present in the lower traveling body deceleration region A3 (Step SP14). More specifically, the determination unit 334 collates the position of the object, which position is specified by the position specification unit 333, with the position of the lower traveling body deceleration region A3 stored in the region storage unit 322, and determines whether the position of the object is inside the lower traveling body deceleration region A3. In a case where the determination unit 334 determines that the object is present in the lower traveling body deceleration region A3 (Yes in Step SP14), the processing proceeds to Step SP15. In a case where the determination unit 334 does not determine that the object is present in the lower traveling body deceleration region A3 (No in Step SP14), the processing proceeds to Step SP16.

In a case where the determination unit 334 determines that the object is present in the lower traveling body deceleration region A3 (Yes in Step SP14), the controller 300 generates a control command to decelerate the lower traveling body 2 (Step SP15). More specifically, for example, when the excavator 1 is traveling, the control unit 336 generates a control command to regulate traveling in such a manner that the traveling speed becomes equal to or lower than the deceleration speed regardless of the operation amount.

Note that in Step SP15, the control unit 336 may generate a control command to maintain a state in which the traveling speed of the lower traveling body 2 is regulated to the deceleration speed or lower, for example, until the cancellation operation of the deceleration control by the operator is detected.

The controller 300 determines whether the object is present in the lower traveling body stop region A2 (Step SP16). More specifically, the determination unit 334 collates the position of the object which position is specified by the position specification unit 333 with the position of the lower traveling body stop region A2 stored in the region storage unit 322, and determines whether the position of the object is inside the lower traveling body stop region A2. In a case where the determination unit 334 determines that the object is present in the lower traveling body stop region A2 (Yes in Step SP16), the processing proceeds to Step SP17. In a case where the determination unit 334 does not determine that the object is present in the lower traveling body stop region A2 (No in Step SP16), the processing proceeds to Step SP18.

In a case where the determination unit 334 determines that the object is present in the lower traveling body stop region A2 (Yes in Step SP16), the controller 300 generates a control command to stop the lower traveling body 2 (Step SP17). More specifically, for example, when the excavator 1 is traveling, the control unit 336 generates a control command to regulate traveling in such a manner that the traveling speed becomes the stop speed or lower regardless of the operation amount.

Note that in Step SP17, for example, the control unit 336 may generate a control command to maintain a state in which the traveling speed of the lower traveling body 2 is regulated to the stop speed or lower until the cancellation operation of the traveling stop control by the operator is detected.

The controller 300 determines whether the object is present in the upper turning body region A1 (Step SP18). More specifically, the determination unit 334 collates the position of the object, which position is specified by the position specification unit 333, with the position of the upper turning body region A1 stored in the region storage unit 322, and determines whether the position of the object is inside the upper turning body region A1. In a case where the determination unit 334 determines that the object is present in the upper turning body region A1 (Yes in Step SP18), the processing proceeds to Step SP19. In a case where the determination unit 334 does not determine that the object is present in the upper turning body region A1 (No in Step SP18), the processing proceeds to Step SP20.

In a case where the determination unit 334 determines that the object is present in the upper turning body region A1 (Yes in Step SP18), the controller 300 generates a control command to regulate the turn of the upper turning body 3 (Step SP19). More specifically, for example, when the excavator 1 is turning, the control unit 336 generates the control command to regulate the turn in such a manner that the turning angular velocity becomes equal to or lower than the upper limit angular velocity regardless of the operation amount.

Note that in Step SP19, the control unit 336 may generate a control command to maintain a state in which the turning angular velocity of the upper turning body 3 is regulated to the upper limit angular velocity or lower, for example, until the cancellation operation of the turning stop control by the operator is detected.

The controller 300 outputs the control command (Step SP20). More specifically, the output unit 337 outputs the control command generated by the control unit 336 to the control valve 19. The control command generated in Step SP15 is output by the output unit 337, whereby the traveling speed of the lower traveling body 2 is regulated to the deceleration speed or lower. Furthermore, the control command generated in Step SP17 is output by the output unit 337, whereby the traveling speed of the lower traveling body 2 is regulated to the stop speed or lower. Furthermore, the control command generated in Step SP19 is output by the output unit 337, the turning angular velocity of the upper turning body 3 is regulated to the upper limit angular velocity or lower.

By constantly executing the above processing during the operation of the excavator 1, the controller 300 controls the excavator 1.

### Computer System

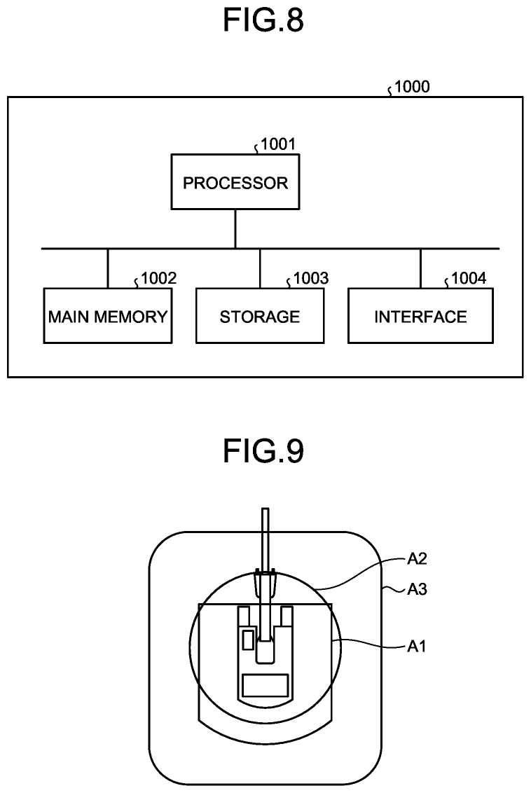

FIG. 8 is a block diagram illustrating a computer system according to the embodiment. The above-described arithmetic processing unit 33 includes the computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. A function of the above-described arithmetic processing unit 33 is stored as a computer program in the storage 1003. The processor 1001 reads the computer program from the storage 1003, develops the computer program in the main memory 1002, and executes the above-described processing according to the computer program. Note that the computer program may be distributed to the computer system 1000 through a network.

In accordance with the above-described embodiment, the computer program or the computer system 1000 causes the detection device 200 to detect an object present around the excavator 1 as first processing, and causes, as second processing, the controller 300 that controls the operation of the lower traveling body 2 and the upper turning body 3 of the excavator 1 to control the operation of the lower traveling body 2 on the basis of the position of the detected object and the lower traveling body stop region A2 and the lower traveling body deceleration region A3 that are the lower traveling body region set in the coordinate system based on the upper turning body 3, and to control the operation of the upper turning body 3 on the basis of the position of the detected object and the upper turning body region A1.

In such a manner, the operation of the lower traveling body 2 is controlled on the basis of the position of the detected object and the lower traveling body stop region A2 and the lower traveling body deceleration region A3 that are the lower traveling body region set in the coordinate system based on the upper turning body 3, and the operation of the upper turning body 3 is controlled on the basis of the position of the detected object and the upper turning body region A1.

### Effect

As described above, in the present embodiment, it is possible to control the operation of the lower traveling body 2 on the basis of the lower traveling body stop region A2 and the lower traveling body deceleration region A3 that are the lower traveling body region set in the coordinate system based on the upper turning body 3, and to control the operation of the upper turning body 3 on the basis of the position of the detected object and the upper turning body region A1. In the present embodiment, the control of the lower traveling body 2 and the upper turning body 3 are determined in different regions. In the present embodiment, it is possible to appropriately control each of the lower traveling body 2 and the upper turning body 3.

In the present embodiment, the lower traveling body regions are set in the coordinate system based on the upper turning body 3. According to the present embodiment, when the positional relationship between the lower traveling body region and the object is grasped, detection of a turning angle or coordinate transformation for unification of the coordinate system is not necessary. The present embodiment can reduce the load of the calculation processing.

### First Modification Example

FIG. 9 is a schematic view illustrating another example of an upper turning body region and a lower traveling body region. An upper turning body region A1 and a lower traveling body stop region A2 are the same as those in FIG. 5. A lower traveling body deceleration region A3 illustrated in FIG. 9 has a shape in which a corner portion of the lower traveling body deceleration region A3 illustrated in FIG. 5 is formed in an arc shape. The lower traveling body deceleration region A3 illustrated in FIG. 9 is smaller in area than the lower traveling body deceleration region A3 illustrated in FIG. 5. Since the lower traveling body deceleration region A3 is formed in such a shape, it is possible to prevent inadvertent deceleration of a lower traveling body 2.

### Second Modification Example

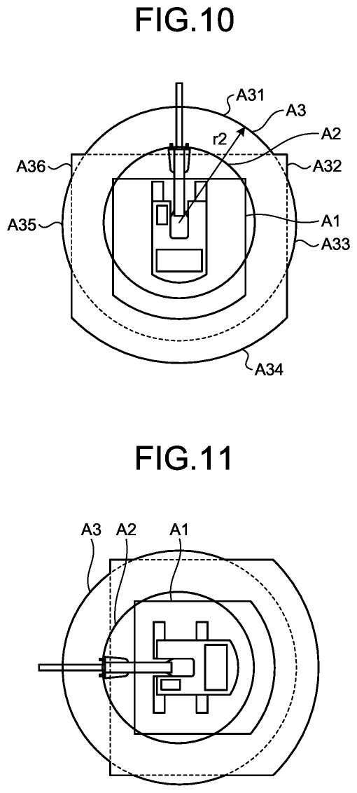

FIG. 10 is a schematic view illustrating another example of an upper turning body region and a lower traveling body region. FIG. 11 is a schematic view illustrating the upper turning body region and the lower traveling body region illustrated in FIG. 10 in a state in which an upper turning body turns. An upper turning body region A1 and a lower traveling body stop region A2 are the same as those in FIG. 5. A lower traveling body deceleration region A3 illustrated in FIG. 10 is a region surrounded by an outer peripheral edge portion of a region acquired by extension of the upper turning body region A1 and the lower traveling body stop region A2 in a radial direction around a turning axis RX of an upper turning body 3. The lower traveling body deceleration region A3 is a region surrounded by a front portion A31 that is a part of a circle having a radius r2, a right corner portion A32 that is a part of a region acquired by extension of the upper turning body region A1, a right side portion A33 that is a part of the circle having the radius r2, a rear portion A34 that is a part of the region acquired by the extension of the upper turning body region A1, a left side portion A35 that is a part of the circle having the radius r2, and a left corner portion A36 that is a part of the region acquired by the extension of the upper turning body region A1.

### Third Modification Example

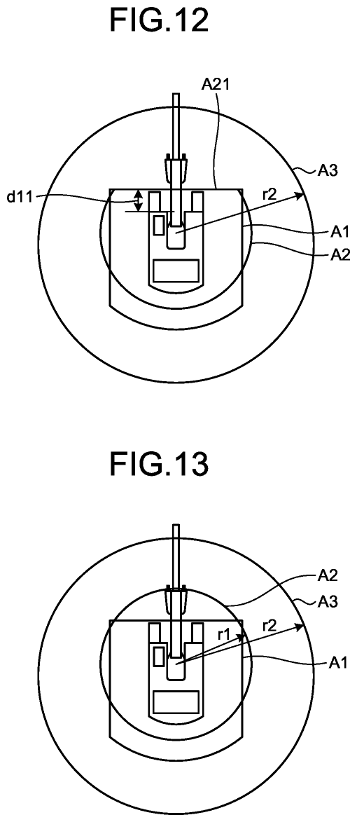

FIG. 12 is a schematic view illustrating another example of an upper turning body region and a lower traveling body region. An upper turning body region A1 and a lower traveling body deceleration region A3 are the same as those in FIG. 5. The lower traveling body stop region A2 illustrated in FIG. 10 is a region in which an arc-shaped front portion A21 of the lower traveling body stop region A2 illustrated in FIG. 5 is a straight portion A21 located on a front side of a front end portion of an upper turning body 3 by a distance d11.

### Fourth Modification Example

FIG. 13 is a schematic view illustrating another example of an upper turning body region and a lower traveling body region. An upper turning body region A1 and a lower traveling body stop region A2 are the same as those in FIG. 5. A lower traveling body deceleration region A3 is a region surrounded by a circle that has a radius r2 (r1<r2) and is centered on a turning axis RX of an upper turning body 3.

### Fifth Modification Example

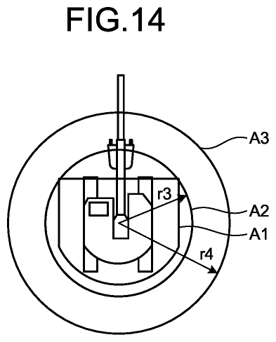

FIG. 14 is a schematic view illustrating another example of an upper turning body region and a lower traveling body region. An excavator 1 illustrated in FIG. 14 is a small-turning excavator (such as a rear ultra-small turning excavator, an ultra-small turning excavator, or the like) having a smaller turning radius than the excavator 1 illustrated in FIG. 5. An upper turning body region A1 is a region formed similarly to the upper turning body region A1 illustrated in FIG. 5 according to a size of the excavator 1. A lower traveling body stop region A2 is a region surrounded by a circle that has a radius r3 and is centered on a turning axis RX of an upper turning body 3. A lower traveling body deceleration region A3 is a region surrounded by a circle that has a radius r4 (r3<r4) and is centered on the turning axis RX of the upper turning body 3. In the example illustrated in FIG. 14, the entire upper turning body region A1 is inside the lower traveling body stop region A2.

### Other Embodiments

Although it has been described in the above-described embodiment that the detection device 200 is the cameras 20 that photograph the periphery of the work machine 1, this is not a limitation. For example, the detection device 200 may be a stereo camera or laser imaging detection and ranging (LIDAR) provided in the excavator 1, or may detect the object by using a radar device or an ultrasonic device.

In addition, although it has been described that the control system 400 according to the above-described embodiment is installed in the excavator 1, this is not a limitation. A part or all of the configuration of the control system 400 may be installed outside the excavator 1. For example, the controller 300 may be arranged in an operation room at a remote location and may control the excavator 1 related to remote operation.

Furthermore, the controller 300 according to the above-described embodiment may include one or a plurality of controllers. For example, in another embodiment, a first controller to acquire detection data from a detection device 200 and detect an object including a person and a moving body present around an excavator 1, and a second controller to specify a position of the object, determine a region where the object is present, and control the excavator 1 may be included.

Although it has been described that the controller 300 according to the above-described embodiment performs control to stop the lower traveling body 2 in a case of determining that the position of the object in the coordinate system based on the upper turning body 3 which object is detected by the detection device 200 is present in the lower traveling body stop region A2, this is not a limitation. For example, in a case where it is determined that the position of the object in the coordinate system based on the upper turning body 3 which object is detected by the detection device 200 is present in either the lower traveling body stop region A2 or the upper turning body region A1, the controller 300 may control the lower traveling body 2 to stop.

In the second modification example, the lower traveling body deceleration region A3 may be two regions that are a first deceleration region acquired by extension of the upper turning body region A1 in a radial direction about the turning axis RX of the upper turning body 3 and a second deceleration region acquired by extension of the lower traveling body stop region A2 in the radial direction about the turning axis RX of the upper turning body 3. In this case, in a case where the object is detected in either the first deceleration region or the second deceleration region, the lower traveling body 2 may be decelerated.

Although it has been described in the above-described embodiment that the work machine 1 is an excavator driven by hydraulic pressure, this is not a limitation. A work machine 1 may be, for example, an electric excavator that uses electric power from a battery or a generator as a power source. In this case, a swing motor 16, a right traveling motor 15R, and a left traveling motor 15L may be electric motors, and a controller 300 may control the swing motor 16, the right traveling motor 15R, and the left traveling motor 15L.

In the above-described embodiment, the excavator 1 may be a mining excavator used in a mine or the like, or may be an excavator used in a construction site. In addition, application to a control system for a dump truck, a wheel loader, or another work machine is possible.

### REFERENCE SIGNS LIST

1 EXCAVATOR (WORK MACHINE)
2 LOWER TRAVELING BODY (TRAVELING BODY)
3 UPPER TURNING BODY (TURNING BODY)
4 WORKING EQUIPMENT
4A BOOM
4B ARM
4C BUCKET
5 HYDRAULIC CYLINDER
5A BOOM CYLINDER
5B ARM CYLINDER
5C BUCKET CYLINDER
6 CAB
9 DRIVER SEAT
10 OPERATION DEVICE
11 LEFT WORKING LEVER
12 RIGHT WORKING LEVER
13 LEFT TRAVELING LEVER
14 RIGHT TRAVELING LEVER
15R RIGHT TRAVELING MOTOR
15L LEFT TRAVELING MOTOR
16 SWING MOTOR
17 POWER SOURCE
18 HYDRAULIC PUMP
19 CONTROL VALVE
20 CAMERA
21 REAR CAMERA
22 RIGHT REAR CAMERA
23 RIGHT FRONT CAMERA
24 LEFT REAR CAMERA
32 STORAGE UNIT
33 ARITHMETIC PROCESSING UNIT
200 DETECTION DEVICE
300 CONTROLLER
321 FEATURE AMOUNT STORAGE UNIT
322 REGION STORAGE UNIT
331 DATA ACQUISITION UNIT
332 DETECTION UNIT
333 POSITION SPECIFICATION UNIT
334 DETERMINATION UNIT
335 OPERATION SIGNAL ACQUISITION UNIT
336 CONTROL UNIT
337 OUTPUT UNIT
400 CONTROL SYSTEM
1000 COMPUTER SYSTEM
1001 PROCESSOR
1002 MAIN MEMORY
1003 STORAGE
1004 INTERFACE
A1 UPPER TURNING BODY REGION (SECOND SET REGION)
A2 LOWER TRAVELING BODY STOP REGION (FIRST SET REGION)
A3 LOWER TRAVELING BODY DECELERATION REGION (THIRD SET REGION)
AX BOOM ROTATION AXIS
BX ARM ROTATION AXIS
CX BUCKET ROTATION AXIS
RX TURNING AXIS

1. A system to control a work machine including a traveling body and a turning body that can turn with respect to the traveling body, the system comprising:
a detection device that is attached to the turning body and detects an object present around the work machine; and
a controller that controls operation of the traveling body and the turning body of the work machine, wherein
the controller
controls the operation of the traveling body on a basis of a position of the object detected by the detection device and a first set region, and
controls the operation of the turning body on a basis of the position of the object detected by the detection device and a second set region different from the first set region, and
the first set region is set in a coordinate system based on the turning body.

2. The system according to claim 1, wherein
the detection device detects a position of the object in the coordinate system based on the turning body, and
the controller performs control to limit a speed of the traveling body in a case of determining that the position of the object detected by the detection device in the coordinate system based on the turning body is present in the first set region.

3. The system according to claim 2, wherein
the second set region is set in the coordinate system based on the turning body, and
the controller performs control to limit a turn of the turning body in a case of determining that the position of the object detected by the detection device in the coordinate system based on the turning body is present in the second set region.

4. The system according to claim 1, wherein
the controller controls the traveling body to decelerate on a basis of the position of the object detected by the detection device and a third set region different from the first set region and the second set region and wider than the first set region, and
the third set region is set in the coordinate system based on the turning body.

5. The system according to claim 1, wherein
in the first set region, at least a part of an outer peripheral shape has an arc shape centered on an origin of the coordinate system based on the turning body.

6. A method of controlling a work machine including a traveling body and a turning body that can turn with respect to the traveling body, the method comprising:
detecting an object present around the work machine by a detection device attached to the turning body; and
controlling operation of the traveling body on a basis of a position of the object detected by the detection device and a first set region, and controlling operation of the turning body on a basis of the position of the object detected by the detection device and a second set region different from the first set region by a controller that controls the operation of the traveling body and the turning body of the work machine, wherein
the first set region is set in a coordinate system based on the turning body.
